(19) United States
(12) Patent Application Publication
(10) Pub. No.: US 2021/0172391 A1
(43) Pub. Date: Jun. 10, 2021

(54) EVAPORATIVE EMISSION CONTROL SYSTEM

(71) Applicant: MAHLE International GmbH, Stuttgart (DE)

(72) Inventors: Thomas Ehlert, Boblingen (DE); Achim Gommel, Weil der Stadt (DE); John Jackson, Oxford, MI (US); Simon Streng, Stuttgart (DE); Melanie Volz, Konigsbach (DE)

(73) Assignee: MAHLE International GmbH

(21) Appl. No.: 16/707,107

(22) Filed: Dec. 9, 2019

(51) Int. Cl. F02D 41/00; F02M 25/08; B60K 15/03; B01D 53/22; B01D 53/04; B01D 71/02

(52) U.S. Cl. CPC F02D 41/003; F02M 25/0836; F02M 25/0872; B60K 15/03; B01D 2259/4516; B01D 53/04; B01D 71/02; B01D 2253/102; B01D 2257/702; B01D 53/229

(57) ABSTRACT

An evaporative emission control system for an automotive vehicle having an internal combustion engine and a fuel tank includes a membrane module disposed and connected between the internal combustion engine and the fuel tank, and configured to reduce discharge of fuel vapor generated from the fuel tank to the atmosphere. The membrane module includes a first passage and a second passage separated by a membrane, and the fuel vapor permeates the membrane in the membrane module. The evaporative emission control system further includes a buffer-volume housing connected to the membrane module by an additional passage and configured for storing fuel-rich vapor that has permeated the membrane. Furthermore, the evaporative emission control system includes an activated carbon filter disposed between the fuel tank and the membrane module, and a purge valve disposed between the membrane module and the engine.

### FIELD

The present disclosure relates to an evaporative emission control system, and more particularly relates to an evaporative fuel vapor emission control system for reducing the discharge of evaporative fuel vapor in an automotive vehicle with a combustion engine.

### BACKGROUND

An evaporative emission control system is well known, for example in a motor vehicle having an internal combustion engine, to prevent fuel vapor from being emitted from the fuel tank into the atmosphere during rest time. The fuel vapor is a major potential source of hydrocarbon (HC) air pollution. Such emissions can be controlled by the evaporative emission control system in the vehicle. The control system typically includes a carbon canister system for adsorbing the fuel vapor. The adsorbed fuel vapor is periodically purged from the activated carbon while the vehicle engine is running by drawing ambient air through the canister system to desorb the fuel vapor from the activated carbon.

When a motor vehicle is parked in a warm environment during the daytime, the temperature in a fuel tank of the motor vehicle increases, resulting in an increased vapor pressure in the fuel tank. In addition, when the motor vehicle stops at an intersection or is driven by an electric motor in a hybrid system that selectively utilizes either or both the internal combustion engine and the electric motor, the amount of the fuel vapor in the fuel tank is increased. As a result, there is a possibility that the fuel vapor generated in the fuel tank will exceed the absorption-storage capability of the canister system, and the excessive fuel vapor in the fuel tank may be vented improperly, resulting in reduced engine performance and the possibility of impermissibly increased fuel vapor emissions into the atmosphere.

To reduce the discharge of the fuel vapor into the atmosphere, a variety of the evaporative emission control systems are continuously developed. However, it is difficult to comply with developing legal requirements with increasingly strict limits.

### SUMMARY

It is the object of the present application to provide an evaporative emission control system meeting strict emission standards.

According to one aspect of the present disclosure, the evaporative emission control system in a vehicle having an internal combustion engine and a fuel tank includes a membrane module disposed and connected between the fuel tank and the engine in the vehicle. The membrane module includes a first passage and a second passage separated by a membrane and is configured for allowing fuel vapor generated from the fuel tank to permeate the membrane. The evaporative emission control system further includes a buffer-volume housing connected to the membrane module by an additional passage and configured for storing fuel-rich vapor that has permeated the membrane.

The buffer-volume housing is connected to the second passage in the membrane module for transmitting the fuel-rich vapor via the additional passage.

The buffer-volume housing in the evaporative emission control system is configured to increase a partial-pressure difference of the fuel vapor between the first passage and the second passage inside the membrane module.

Furthermore, the fuel-rich vapor flows into the buffer-volume housing when the engine of the vehicle is an idle state or the vehicle is parked at a warm environment. A purge valve is configured to allow the fuel-rich vapor stored in the second passage of the membrane module and the buffer-volume housing to flow into the engine when the engine of the vehicle is running above an idle speed.

The buffer-volume housing is formed of a plastic material.

According to a further aspect of the present disclosure, the membrane module includes a membrane inlet for receiving the generated fuel vapor from the fuel tank, an atmosphere outlet for discharging air including the fuel vapor that has not permeated, an atmosphere inlet for receiving atmospheric air from the atmosphere, and a membrane outlet for allowing the fuel-rich vapor to flow into the engine.

According to a further aspect of the present disclosure, the membrane inlet and the atmosphere outlet communicate with each other through the first passage in the membrane module, and the atmosphere inlet and the membrane outlet communicate with each other through the second passage in the membrane module.

According to a further aspect of the present disclosure, the membrane inlet is connected to a fuel vapor inlet line for communicating with the fuel tank and the membrane outlet is connected to a fuel vapor outlet line for communicating with the engine.

According to a further aspect of the present disclosure, a relief valve disposed between the fuel tank and the membrane module is configured to control flow of the fuel vapor generated from the fuel tank.

According to a further aspect of the present disclosure, an activated carbon filter disposed between the relief valve and the membrane module is configured to adsorb hydrocarbon (HC) in the generated fuel vapor before entering the membrane module.

According to a further aspect of the present disclosure, a purge valve disposed between the membrane module and the engine is configured to control flow of the fuel-rich vapor entering the engine.

According to a further aspect of the present disclosure, the membrane formed as a flat shape includes a main body and a plurality of support elements formed with the main body. The main body of the membrane is formed of a silicon material as an active layer.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In the drawings,

FIG. 1 shows a schematic view of a vehicle having an evaporative emission control system in accordance with an exemplary form of the present disclosure;

FIG. 2 shows a membrane module of the evaporative emission control system of FIG. 1;

FIG. 3 shows a diffusion mechanism of a membrane in the membrane module of FIG. 2; and

FIG. 4 shows a buffer-volume housing connected to the membrane module of the evaporative emission control system of FIG. 1.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

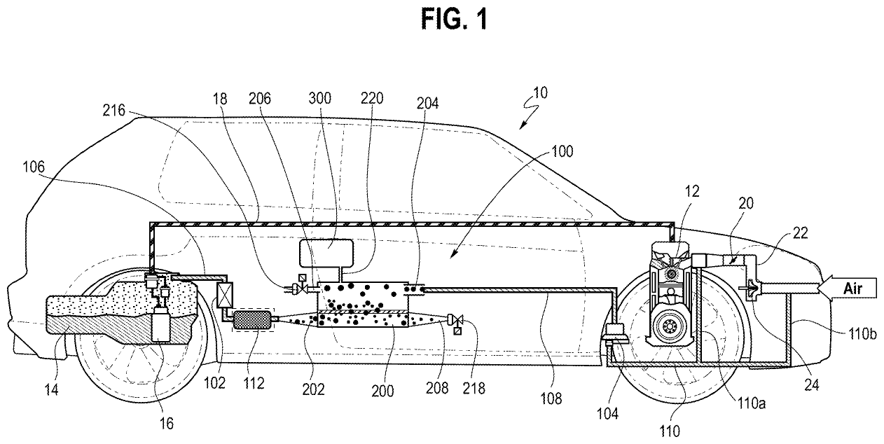

FIG. 1 illustrates an evaporative emission control system 100 for an automotive vehicle 10. In the example of FIG. 1, the evaporative emission control system 100 is shown in the vehicle 10 having an internal combustion engine 12 and a fuel tank 14. In addition, the evaporative emission control system 100 may be used to a hybrid vehicle that selectively utilizes two power systems such as the internal combustion engine 12 and an electric motor (not shown). As shown in FIG. 1, the fuel tank 14 includes a fuel pump assembly 16 used in the vehicle 10 for delivering fuel from the fuel tank 14 to the engine 12 for combustion within the engine 12. A fuel line 18 connected between the engine 12 and the fuel tank 14 communicates with the fuel pump assembly 16 for delivering the fuel to the engine 12.

A throttle valve 20 is disposed in an air inlet line 22 of the internal combustion engine 12 to control the engine's power by regulating the amount of fuel (such as fuel vapor) or air entering the engine 12. In the vehicle 10, for example, the control of the throttle valve 20 is performed by an operator (or a driver) to regulate the power with an accelerator or gas pedal. Furthermore, a compressor 24 disposed in the air inlet line 22 upstream of the throttle valve 20 controls the engine's power by compressing the air entering the engine 12.

As shown in FIG. 1, the evaporative emission control system 100 is installed in the vehicle 10 for preventing fuel vapor from being emitted from the fuel tank 14 into the atmosphere during rest time. The evaporative emission control system 100 includes a relief (or check) valve 102, a purge valve 104, a fuel vapor inlet line 106, a fuel vapor outlet line 108, a purge outlet line 110 including a first purge outlet line 100a and a second purge outlet line 110b, and a membrane module 200. The relief valve 102 is disposed in the fuel vapor inlet line 106 connected between the fuel tank 14 and the membrane module 200 for controlling the amount of the fuel vapor entering the membrane module 200.

The evaporative emission control system 100 further includes an activated carbon filter 112 disposed in the fuel vapor inlet line 106. The activated carbon filter 112 may be provided upstream of the membrane module 200 as viewed along the vapor path from the fuel tank 14. As shown in FIG. 1, the activated carbon filter 112 is installed between the fuel tank 14 and the membrane module 200, so that the fuel vapor flows into the carbon filter 112 before entering the membrane module 200. Alternatively, however, the evaporative emission control system 100 may be modified to place the carbon filter 112 downstream of the membrane module 200. Accordingly, the activated carbon filter 112 may be installed between the membrane module 200 and the internal combustion engine 12 (not shown), so that the fuel vapor enters the membrane module 200 before entering the carbon filter 112.

As shown in FIG. 1, the evaporative emission control system 100 includes the membrane module 200 for selectively separating hydrocarbon (HC) vapor from other air constituents in the fuel vapor generated in the fuel tank 14. The membrane module 200 is disposed between the internal combustion engine 12 and the fuel tank 14, and communicates with the relief valve 102 for receiving the fuel vapor generated from the fuel tank 14 via the fuel vapor inlet line 106. The membrane module 200 includes a membrane inlet 202 connected to the fuel vapor inlet line 106 for communicating with the fuel tank 14, and a membrane outlet 204 connected to the fuel vapor outlet line 108 for communicating with the internal combustion engine 12. For example, when the carbon filter 112 is installed between the membrane module 200 and the relief valve 102, the membrane inlet 202 communicates with the carbon filter 112. When the carbon filter 112 is alternatively installed between the membrane module 200 and the purge valve 104, the membrane outlet 204 communicates with the carbon filter 112.

In FIG. 1, the purge valve 104 between the membrane module 200 and the internal combustion engine 12 is provided to control the fuel vapor entering the internal combustion engine 12. The membrane outlet 204 is connected to the fuel vapor outlet line 108 which leads the fuel vapor to the engine 12 of the vehicle 10. The purge valve 104 is disposed in the fuel vapor outlet line 108 for controlling the purge cycle of the fuel vapor from the membrane module 200 such that the purge valve 104 activates and deactivates flow of the fuel vapor entering the engine 12 from the membrane module 200.

As shown in FIG. 1, the purge valve 104 is preferably a solenoid operated valve controlled by an electronic controller unit (ECU) of the vehicle 10 (not shown). The purge valve 104 is normally closed when the vehicle 10 is not running (for example, the vehicle 10 is parked or the engine 12 of the vehicle 10 is running in its idle speed). The purge valve 104 is typically opened and activates the flow of the fuel vapor from the membrane module 200 when the engine 12 is running above its idle speed. When the purge valve 104 is opened, atmospheric air drawn through the air inlet line 22 and the purged fuel vapor flown through the purge outlet line 110 are mixed, and the mixed fuel vapor and the air enter the engine 12. For example, the purged fuel vapor may be mixed with the air just before entering the engine 12 via the first purge outlet line 110a or the purged fuel vapor may be mixed with the air before entering the compressor 24 via the second purge outlet line 110b.

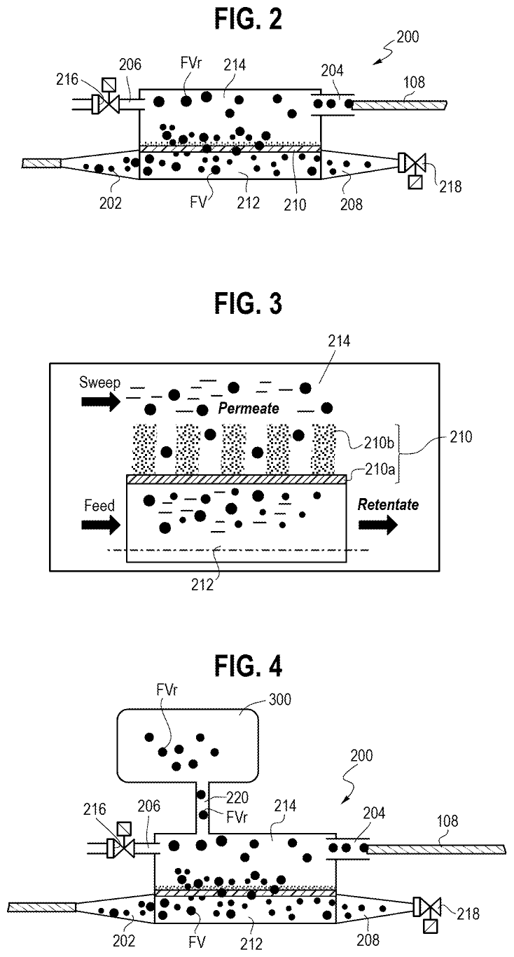

FIG. 2 illustrates the membrane module 200 including the membrane inlet 202, the membrane outlet 204, an atmosphere inlet 206, an atmosphere outlet 208, and a membrane 210. In the membrane module 200, the membrane inlet 202 is connected to the fuel vapor inlet line 106 for receiving fuel vapor FV generated from the fuel tank 14, and the membrane outlet 204 is connected to the fuel vapor outlet line 108 for allowing fuel-rich vapor FVr that has permeated the membrane 210 to flow into the engine 12 by the purge valve 104. In addition, an atmosphere inlet valve 216 is connected to the atmosphere inlet 206 for controlling to receive the atmosphere air entering the membrane module 200, and an atmosphere outlet valve 218 is connected to the atmosphere outlet 208 for controlling to discharge air including fuel vapor FV that has not permeated the membrane 210, to the atmosphere.

In FIG. 2, as described above, the membrane module 200 further includes the membrane 210 for allowing the fuel vapor FV generated from the fuel tank 14 to permeate the membrane 210, and the membrane module 200 is also structurally separated by the membrane 210 as a physical layer even though the fuel vapor FV permeates the membrane 210. Accordingly, the membrane module 200 forms a first passage 212 including the membrane inlet 202 and the atmosphere outlet 208, and a second passage 214 including the membrane outlet 204 and the atmosphere inlet 206. The membrane 210 is formed as a flat shape and/or an asymmetric structure. However, various shapes or structures of the membrane 210 may be implemented in modifications of the shown evaporative emission control system 100.

Referring to FIG. 3, the membrane 210 of the membrane module 200 includes a main body 210a formed as an active layer and a plurality of support elements 210b formed with the main body 210a. The material of the main body 210a may be an organic material such a silicon. FIG. 3 illustrates a solution-diffusion mechanism of the membrane 210 such that the fuel vapor FV generated from the fuel tank 14 permeates the membrane 210 in the membrane module 200. The generated fuel vapor FV from the fuel tank 14 passes through the carbon filter 112, and the fuel vapor FV exiting the carbon filter 112 enters the membrane module 200 via the membrane inlet 202, which is called “Feed” process. The entered fuel vapor FV adsorbs to the surface of the membrane 210 in the first passage 212, and then the fuel vapor FV diffuses across the membrane 210 through micro-channels of the main body 210a and the support elements 210b. Finally, the fuel vapor FV desorbs from the opposite surface of the membrane 210 in the second passage 214 of the membrane module 200, which is called “Permeate” process. The driving force for the permeation of the fuel vapor FV across the membrane 210 lies the partial pressure difference of the fuel vapor FV between both sides (the first passage 212 and the second passage 214) of the membrane 210. In particular, the partial pressure difference of the fuel vapor FV may be high near the membrane inlet 202 in the first passage 212, while in the second passage 214 of the membrane module 200 may have a comparatively low fuel vapor FV partial pressure. Accordingly, the solution-diffusion mechanism drives the permeation of the fuel vapor FV across the membrane 210. As noted above, the separated fuel vapor FV in the second passage 214 is defined as the fuel-rich vapor FVr.

After the Permeate process, in the first passage 212 of the membrane module 200, air including the fuel vapor FV that has not permeated the membrane 210 is discharged to the atmosphere via the atmosphere outlet 208, which is called “Retentate” process. In addition, atmospheric air flows into the second passage 214 of the membrane module 200 via the atmosphere inlet 206 for sweeping the fuel-rich vapor FVr away from the opposite surface of the membrane 210, which is called “Sweep” process. Due to the Sweep process, the fuel-rich vapor FVr is separated from the opposite surface of the membrane 210.

Referring back to FIG. 1, the evaporative emission control system 100 further includes a buffer-volume housing 300. In the evaporative emission control system 100, the membrane module 200 includes an additional passage 220 connected to the buffer-volume housing 300. In particular, the additional passage 220 is connected to the second passage 214 of the membrane module 200. For example, as shown in FIG. 1, the additional passage 220 may be a tube connection. Alternatively, however, an integrated version of the tube into the membrane module 200 may be implemented as the additional passage 22 (not shown). The buffer-volume housing 300 is made from a plastic material inert to fuel vapor, such as polyethylene, polymerizing vinyl chloride (PVC), nylon, etc., and also formed as any type of shape such as a box shape or a cylindrical shape for fitting into a limited space of the vehicle 10.

Referring to FIG. 4, the buffer-volume housing 300 connected to the membrane module 200 is configured to store the fuel-rich vapor FVr such that the buffer-volume housing 300 is used as an additional storage of the fuel-rich vapor FVr. In the membrane module 200, as described above, as more fuel vapor FV permeates the membrane 210, the partial-pressure difference of the fuel vapor FV between both sides of the membrane 210 is decreased so that the driving force for the permeation of the fuel vapor FV across the membrane 210 is reduced. However, due to the buffer-volume housing 300 connected to the second passage 214 of the membrane module 200, the partial pressure difference of the fuel vapor FV between both sides of the membrane 210 is maintained and more fuel vapor FV generated from the fuel tank 14 permeates the membrane 210. The fuel-rich vapor FVr that has permeated the membrane 210 is freely transmitted via the additional passage 220 (e.g. a tube) between the membrane module 200 and the buffer-volume housing 300.

As shown in FIG. 4, due to the buffer-volume housing 300 as the additional storage, the space for storing the fuel-rich vapor FVr is increased so that the partial pressure difference of the fuel vapor FV between both sides of the membrane 210 remains large. Accordingly, more fuel vapor FV is able to permeate the membrane 210 and is stored in the second passage 214 of the membrane module 200 and the buffer-volume housing 300. The evaporative emission control system 100 with the buffer-volume housing 300 reduces the discharge of the fuel vapor FV that has not permeated to the atmosphere.

In addition, as long as the vehicle 10 remains in the idle state of the engine 12, fuel vapor FV is generated from the fuel tank 14. For example, when a hybrid vehicle is driven by an electric motor for a long time or the vehicle 10 is parked in a warm environment for a long time, more fuel vapor FV evaporates from the fuel tank 14. During the idle state of the engine 12 in the vehicle 10, the fuel-rich vapor FVr (that has permeated the membrane 210) accumulates in the membrane module 200 and the buffer-volume housing 300 instead of flowing into the engine 12. Accordingly, due to the buffer-volume housing 300 as the additional storage for storing the fuel-rich vapor FVr, more fuel vapor FV generated from the fuel tank 14 permeates the membrane 210 in the membrane module 200.

In addition, the buffer-volume housing 300 is an additional structure for storing the fuel-rich vapor FVr before being sucked into the engine 12. Accordingly, the evaporative emission control system 100 with both the membrane module 200 and the buffer-volume housing 300 enables the vehicle 10 to install the evaporative emission control system 100 with flexibility in the limited space of the vehicle 10 having surrounding components. For example, the evaporative emission control system 100 may utilize a smaller membrane module 200 combined with a bigger buffer-volume housing 300 or vice versa. Also, due to the additional storage for the fuel-rich vapor FVr in the evaporative emission control system 100 having the buffer-volume housing 300, the condensate produced above the membrane 210 during the Permeate process in the membrane module 200 may be reduced.

While the above description constitutes the preferred embodiments of the present invention, it will be appreciated that the invention is susceptible to modification, variation and change without departing from the proper scope and fair meaning of the accompanying claims.

1. An evaporative emission control system for a vehicle having an engine and a fuel tank, the evaporative emission control system comprising:
a membrane module disposed and connected between the fuel tank and the engine in the vehicle, the membrane module including a first passage and a second passage separated by a membrane and being configured for allowing fuel vapor generated from the fuel tank to permeate the membrane; and
a buffer-volume housing connected to the membrane module by an additional passage and configured for storing fuel-rich vapor that has permeated the membrane,
wherein all communication of the fuel vapor from the fuel tank to the buffer-volume housing extends through the membrane in the membrane module,
wherein the second passage of the membrane module includes a membrane outlet connected to a fuel vapor outlet line for allowing the fuel-rich vapor to flow into the engine, and
wherein the additional passage connected to the buffer-volume housing is separate from the fuel vapor line such that all communication of the fuel-rich vapor from the buffer-volume housing to the engine extends through the second passage of the membrane module located between the additional passage and the fuel vapor outlet line.

2. The evaporative emission control system of claim 1, wherein the buffer-volume housing is connected to the second passage in the membrane module for transmitting the fuel-rich vapor via the additional passage.

3. The evaporative emission control system of claim 1, wherein the buffer-volume housing is configured to increase a partial-pressure difference of the fuel vapor between the first passage and the second passage inside the membrane module.

4. The evaporative emission control system of claim 1, wherein the evaporative emission control system is configured to cause fuel-rich vapor to travel into the buffer-volume housing when the engine of the vehicle is an idle state or the vehicle is parked.

5. The evaporation emission control system of claim 1, wherein a purge valve is configured to allow the fuel-rich vapor stored in the second passage of the membrane module and the buffer-volume housing to travel into the engine when the engine of the vehicle is running above an idle speed.

6. The evaporative emission control system of claim 1, wherein the buffer-volume housing is formed of a plastic material.

7. The evaporative emission control system of claim 1, wherein the membrane module further includes a membrane inlet for receiving the generated fuel vapor from the fuel tank, an atmosphere outlet for discharging air including the fuel vapor that has not permeated, and an atmosphere inlet for receiving atmospheric air from the atmosphere.

8. The evaporative emission control system of claim 7, wherein the membrane inlet and the atmosphere outlet communicate with each other through the first passage in the membrane module, and the atmosphere inlet and the membrane outlet communicate with each other through the second passage in the membrane module.

9. The evaporative emission control system of claim 7, wherein the membrane inlet is connected to a fuel vapor inlet line for communicating with the fuel tank.

10. The evaporative emission control system of claim 1, wherein a relief valve disposed between the fuel tank and the membrane module is configured to control flow of the fuel vapor generated from the fuel tank.

11. The evaporative emission control system of claim 10, wherein an activated carbon filter disposed between the relief valve and the membrane module is configured to adsorb hydrocarbon (HC) in the generated fuel vapor before entering the membrane module.

12. The evaporative emission control system of claim 1, wherein a purge valve disposed between the membrane module and the engine is configured to control flow of the fuel-rich vapor entering the engine.

13. The evaporative emission control system of claim 1, wherein the membrane is formed as a flat shape and includes a main body and a plurality of support elements formed on the main body.

14. The evaporative emission control system of claim 13, wherein the main body of the membrane is formed of a silicon material as an active layer.

15. An evaporative emission control system for a vehicle having an engine and a fuel tank, the evaporative emission control system comprising:
a membrane module disposed and connected between the fuel tank and the engine in the vehicle, the membrane module including a first passage and a second passage separated by a membrane and being configured for allowing fuel vapor generated from the fuel tank to permeate the membrane; and
a buffer-volume housing connected to the membrane module by an additional passage and configured for storing fuel-rich vapor that has permeated the membrane,
wherein all communication of the fuel vapor from the fuel tank to the buffer-volume housing extends through the membrane in the membrane module, and
wherein the membrane module further includes an atmosphere inlet for receiving atmospheric air from atmosphere and an atmosphere outlet for discharging air including the fuel vapor that has not permeated.
